(19) United States
(12) Patent Application Publication
(10) Pub. No.: US 2024/0173950 A1
(43) Pub. Date: May 30, 2024

(54) 100% POLYESTER MONO-MATERIAL PROVIDING SUEDE-LIKE A-SURFACE WITH 100% RECYCLABILITY AT END OF LIFE

(71) Applicant: LEAR CORPORATION, Southfield, MI (US)

(72) Inventors: Travis PETERSON, Southfield, MI (US); Larry KOCHER, Orchard Lake, MI (US); Rebecca BERGER, Kenansville, NC (US); Beth THOMAS, Alfreton (GB); Elliot HILL, Alfreton (GB); Sarah SMITH, Alfreton (GB); Scott FOSTER, Alfreton (GB); Kent STEPHENSON, Kenansville, NC (US)

(73) Assignee: LEAR CORPORATION, Southfield, MI (US)

(21) Appl. No.: 18/356,573

(22) Filed: Jul. 21, 2023

Related U.S. Application Data
(60) Provisional application No. 63/385,449, filed on Nov. 30, 2022.

(51) Int. Cl. B32B 27/12; B32B 5/02; B32B 7/12; B32B 27/36

(52) U.S. Cl. CPC B32B 27/12; B32B 5/024; B32B 5/026; B32B 7/12; B32B 27/36; B32B 2250/02; B32B 2262/0276; B32B 2262/16; B32B 2272/00; B32B 2307/718; B32B 2307/7376; B32B 2605/003

(57) ABSTRACT

A cover for vehicle interior components is provided. The cover includes a fabric sheet comprising a yarn composed of polyester microfibers. The fabric sheet has a first face and a second face wherein the first face is an A-side surface with separated and raised microfibers that provide a suede-like appearance and feel. A polyester backing layer is laminated to the fabric sheet.

### CROSS-REFERENCE TO RELATED APPLICATIONS

This application claims the benefit of U.S. provisional application Ser. No. 63/385,449 filed Nov. 30, 2022, the disclosure of which is hereby incorporated in its entirety by reference herein.

### TECHNICAL FIELD

The present disclosure relates to recyclable fabrics for vehicle interior application.

### BRIEF DESCRIPTION OF THE DRAWINGS

FIG. 1 is a cross-sectional view of an exemplary polyester cover according to an embodiment.

FIG. 2 is a flowchart depicting a method of making the exemplary polyester cover of FIG. 1.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It is to be understood that the disclosed embodiments are merely exemplary and that various and alternative forms are possible. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ embodiments according to the disclosure.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: percent, “parts of.” and ratio values are by weight; the term “polymer” includes “oligomer,” “copolymer,” “terpolymer,” and the like; molecular weights provided for any polymers refers to weight average molecular weight unless otherwise indicated; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

With respect to the terms “comprising,” “consisting of,” and “consisting essentially of,” where one of these three terms is used herein, the presently disclosed and claimed subject matter can include the use of either of the other two terms.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4 . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits. In the specific examples set forth herein, concentrations, temperature, and reaction conditions (e.g., pressure, pH, etc.) can be practiced with plus or minus 50 percent of the values indicated rounded to three significant figures. In a refinement, concentrations, temperature, and reaction conditions (e.g., pressure, pH, etc.) can be practiced with plus or minus 30 percent of the values indicated rounded to three significant figures of the value provided in the examples. In another refinement, concentrations, temperature, and reaction conditions (e.g., pH, etc.) can be practiced with plus or minus 10 percent of the values indicated rounded to three significant figures of the value provided in the examples.

### Abbreviations

“dpf” means denier per filament.
“gsm” means grams/square meter.

Vehicle manufacturers and suppliers aim to improve the visual appeal, appearance, and feel of vehicle interior components. Such considerations have influenced the design of vehicle interior and seating trim including, for example, the headliner, visors, sunshade, pillars, package tray, seat cushions, and headrest. Environmental concerns increased desire for renewable, recycled, and/or recyclable content within a vehicle.

Vehicle interior components can include, for example, resinous foams such as polyurethane. Resinous foams can be found in vehicle trim laminates as backing for the fabric, leather, and/or vinyl trim cover. These foams function to provide cushioning or soft feel that is desirable to consumers. While these traditional resinous foams work reasonably well in this regard, they typically do not contain recycled content, are derived from non-renewable petroleum sources, and are not easily recycled or biodegraded.

Accordingly, vehicle interior components which provide a desirable feel, crafted appearance, and are durable enough to last the vehicle life cycle, while being either renewable resource-derived, manufactured using recycled content, or ideally 100% recyclable, are provided.

In at least one embodiment, the present disclosure describes a cover for a vehicle interior component, such as a seat, headliner, or other trim component.

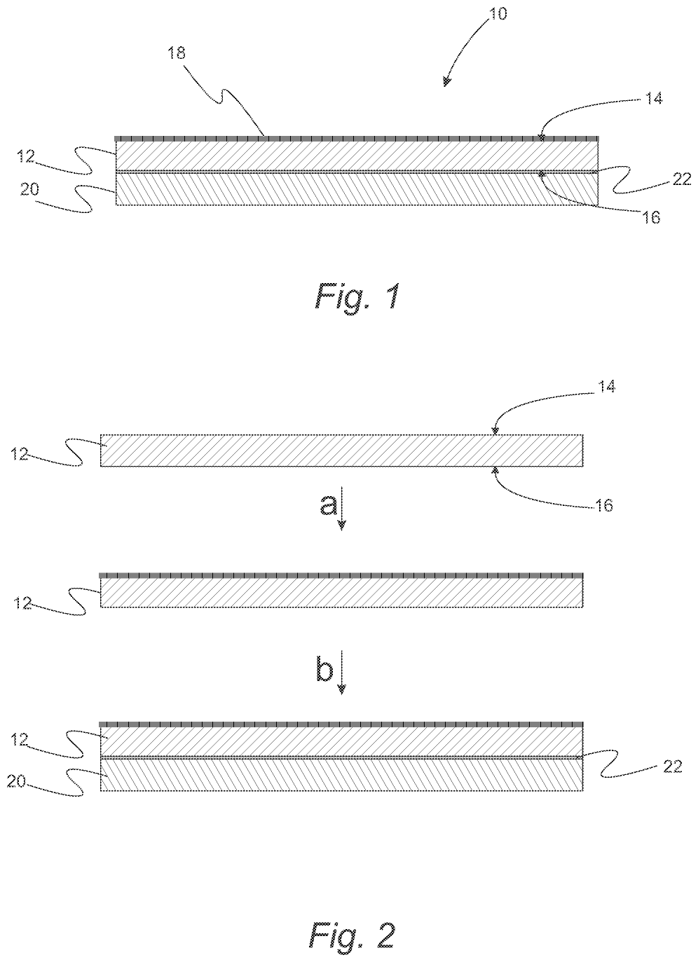

Referring to FIG. 1, a cross-sectional schematic for a 100% polyester mono-material cover for a vehicle interior component is provided. Cover 10 includes a fabric sheet 12 that includes yarn composed of polyester microfibers. In this context, the decitex per filament for a microfiber is less than 1. Fabric sheet 12 has a first face 14 and a second face 16. Characteristically, the first face 14 is an A-side surface with separated and raised microfibers 18 that provide a suede-like appearance and feel at the first face 14. Polyester backing layer 20 is laminated to the fabric sheet 12. In a refinement, fabric sheet 12 is a warp-knitted fabric sheet or a weft-knitted fabric sheet. In another refinement, fabric sheet 12 is a woven fabric sheet. Therefore, fabric sheet 12 can be formed by warp knitting, weft-knitting, weaving, or other textile construction. Advantageously, cover 10 may be used as a trim cover for vehicle interior components including seats, headliners, sunshades, pillars, visors, or package trays.

In another aspect, polyester backing layer 20 is laminated to the fabric sheet 12 with a polyester adhesive layer 22. In a refinement, the polyester adhesive layer 22 includes a polyester-based glue, a polyester film, a polyester powder adhesive, or a polyester web.

In another aspect, polyester in at least one of the fabric sheet 12, the polyester backing layer 20, and the polyester adhesive layer 22 includes recycled polyester, ocean-waste recycled polyester, ocean-bound recycled polyester, or combinations thereof. In a refinement, 70 to 100 weight percent of the polyester in at least one of the fabric sheet 12, the polyester backing layer 20, and the polyester adhesive layer 22 is recyclable.

In at least one aspect, the fabric sheet 12 is constructed such that the A-side surface of the fabric sheet 12 with the first face 14 includes both a face yarn and a ground yarn. As such, the face yarn may contribute to the suede-like appearance by providing the separated and raised microfibers 18. The balance of the fabric sheet 12, interwoven with the face yarn and away from the A-side surface, may be the ground yarn. In another aspect, the face yarn is composed of a polyester yarn having a denier from 0.1 to 0.9 dpf. In a refinement, the ground yarn is composed of a polyester yarn having a denier from 0.1 to 3 dpf. Typically, the fabric sheet 12 has a weight of 150 to 500 gsm. In at least one embodiment, as shown in FIG. 1, the first face 14 includes face yarn with the separated and raised microfibers 18. The first face 14 may also include ground yarn interwoven with the face yarn. In at least one embodiment, the balance of the fabric sheet 12, other than the first face 14, may be ground yarn. Furthermore, in at least one embodiment, a portion, corresponding to the A-side surface, of the first face 14 may be face yarn, while another portion, on a side opposite to the A-side surface, may be ground yarn. As such, the overall fabric sheet 12 may have a first thickness, and the first face 14 may define a second thickness corresponding to a portion of the first thickness. The face yarn may be included in at least a portion of the second thickness, and be positioned towards the A-side surface. The ground yarn may be in at least a portion of the second thickness, in some embodiments. In other embodiments, the ground yarn may be in the balance of the first thickness other than the second thickness. As such, the ground yarn may be interwoven with the face yarn within the first face 14, or may be provided in the thickness of the fabric sheet 12 other than the portion with the face yarns.

In another aspect, the polyester backing layer 20 is nonwoven, knitted, woven, weft-knitted, double-needle bar (e.g., spacer), or back coating. In a refinement, cover 10 may be configured for vehicle headliner applications such that the polyester backing layer has a weight of 50 to 200 gsm and a thickness of 0.5 mm to 10 mm. In another refinement, cover 10 may be configured for vehicle seating applications such that the polyester backing layer has a weight of 50 to 300 gsm and a thickness of 0.5 mm to 10 mm.

Referring to FIG. 2, a flowchart depicting a method for fabricating the cover described above is provided. In step a), the first face 14 of fabric sheet 12 is mechanically finished to separate and raise microfibers to impart a suede-like appearance and feel. In step b), polyester backing layer 20 is laminated to the second face 16 of fabric sheet 12.

In another aspect, the mechanical finishing of step a) may be implemented by at least one of brushing and sueding.

In another aspect, the lamination of step b) may be flame lamination, adhesive lamination via hotmelt or flat bed, or drum lamination. Polyester backing layer 20 may be laminated to the fabric sheet 12 with a polyester adhesive layer 22.

In another aspect, the cover 10 is secondarily processed by embossing, perforation, high-frequency induction welding, quilting, embroidery, printing, and combinations thereof to impart desired aesthetic, structural, or other attributes. In a refinement, the processing may result in a high density design on the cover 10.

It is advantageous to use the polyester mono-material cover described herein for vehicle interior components such that at least a portion of the cover is a recyclable material. Using recyclable polyester yarn and recyclable polyester adhesive in a cover for a vehicle interior component may improve product environmental impact by increasing the recycled material content, green footprint, recyclability, and sustainability.

### ASPECTS

Aspect 1. A cover for vehicle interior components, the cover comprising a fabric sheet comprising a yarn composed of polyester microfibers, the fabric sheet having a first face and a second face wherein the first face is an A-side surface with separated and raised microfibers that provide a suede-like appearance and feel; and a polyester backing layer laminated to the second face of the fabric sheet.

Aspect 2. The cover of aspect 1, wherein the fabric sheet is a warp knitted fabric sheet or a weft-knitted fabric sheet.

Aspect 3. The cover of aspects 1 or 2, wherein the fabric sheet is a woven fabric sheet.

Aspect 4. The cover of any of aspects 1 to 3, wherein the polyester backing layer is laminated to the fabric sheet with a polyester adhesive layer.

Aspect 5. The cover of any of aspects 1 to 4, wherein the polyester adhesive layer includes a polyester-based glue or a polyester film or a polyester web.

Aspect 6. The cover of any of aspects 1 to 5, wherein polyester in at least one of the fabric sheet, the polyester backing layer, and the polyester adhesive layer includes recycled polyester, ocean-waste recycled polyester, ocean-bound recycled polyester, or combinations thereof.

Aspect 7. The cover of any of aspects 1 to 6, wherein 70 to 100 weight percent of the polyester in at least one of the fabric sheet, the polyester backing layer, and the polyester adhesive layer is recyclable.

Aspect 8. The cover of any of aspects 1 to 7, wherein the fabric sheet face is composed of a polyester yarn having a denier from 0.1 to 0.9 dpf.

Aspect 9. The cover of any of aspects 1 to 8, wherein the fabric sheet ground is composed of a polyester yarn having a denier from 0.1 to 3 dpf.

Aspect 10. The cover of any of aspects 1 to 9, wherein the fabric sheet has a weight of 150 to 500 gsm.

Aspect 11. The cover of any of aspects 1 to 10, wherein the fabric sheet is formed by warp knitting, weft-knitting, weaving or other textile construction.

Aspect 12. The cover of any of aspects 1 to 11, wherein the polyester backing layer is a nonwoven, knitted, woven, weft-knitted, spacer, or back coating material.

Aspect 13. The cover of any of aspects 1 to 12, wherein the polyester backing layer has a weight of 50 to 200 gsm and a thickness of 0.5 to 10 mm.

Aspect 14. The cover of any of aspects 1 to 13, wherein the polyester backing layer has a weight of 50 to 300 gsm and a thickness of 0.5 to 10 mm.

Aspect 15. A method for fabricating the cover of any of aspects 1 to 14, the method comprising mechanically finishing the first face of the fabric sheet to separate and raise microfibers to impart a suede-like appearance and feel; and laminating the polyester backing layer to the second face of the fabric sheet.

Aspect 16. The method of aspect 15, wherein lamination is flame lamination, adhesive lamination via hotmelt or flatbed, or drum lamination.

Aspect 17. The method of aspects 15 or 16, wherein the polyester backing layer is laminated to the fabric sheet with a polyester adhesive layer.

Aspect 18. The method of any of aspects 15 to 17, wherein mechanical finishing is implemented by brushing and/or sueding.

Aspect 19. The method of any of aspects 15 to 18, wherein the cover is secondarily processed by embossing, perforation, high-frequency induction welding, quilting, embroidery, printing, high density design (HDD), and combinations thereof.

Aspect 20. A cover for vehicle interior components, the cover comprising: a fabric sheet comprising a yarn composed of polyester microfibers, the fabric sheet comprising a first face and a second face wherein the first face is an A-side surface with separated and raised microfibers that provide a suede-like appearance and feel; and a polyester backing layer laminated to the second face of the fabric sheet.

Aspect 21. The cover of aspect 20, wherein the fabric sheet is a warp knitted fabric sheet or a weft-knitted fabric sheet.

Aspect 22. The cover of aspects 20 or 21, wherein the fabric sheet is a woven fabric sheet.

Aspect 23. The cover of any of aspects 20 to 22, wherein the polyester backing layer is laminated to the fabric sheet with a polyester adhesive layer.

Aspect 24. The cover of any of aspects 20 to 23, wherein the polyester adhesive layer comprises a polyester-based glue or a polyester film or a polyester web.

Aspect 25. The cover of any of aspects 20 to 24, wherein the polyester in at least one of the fabric sheet, the polyester backing layer, and the polyester adhesive layer comprises recycled polyester, ocean-waste recycled polyester, ocean-bound recycled polyester, or combinations thereof.

Aspect 26. The cover of any of aspects 20 to 25, wherein 70 to 100 weight percent of the polyester in at least one of the fabric sheet, the polyester backing layer, and the polyester adhesive layer is recyclable.

Aspect 27. The cover of any of aspects 20 to 26, wherein the fabric sheet further comprises a face yarn and a ground yarn, wherein the face yarn provides the separated and raised microfibers, and the ground yarn is interwoven with the face yarn and located away from the A-side surface when compared with the face yarn and provides support to the face yarn.

Aspect 28. The cover of aspect 27, wherein the face yarn is composed of a polyester yarn having a denier from 0.1 to 0.9 dpf.

Aspect 29. The cover of aspects 27 or 28, wherein the ground yarn is composed of a polyester yarn having a denier from 0.1 to 3 dpf.

Aspect 30. The cover of any of aspects 20 to 29, wherein the fabric sheet has a weight of 150 to 500 gsm.

Aspect 31. The cover of any of aspects 20 to 30, wherein the fabric sheet is formed by warp knitting, weft-knitting, weaving or other textile construction.

Aspect 32. The cover of any of aspects 20 to 31, wherein the polyester backing layer is nonwoven, knitted, woven, weft-knitted, double-needle bar, or back coating.

Aspect 33. The cover of any of aspects 20 to 32, wherein the polyester backing layer has a weight of 50 to 300 gsm and a thickness of 0.5 mm to 10 mm.

Aspect 34. The cover of any of aspects 20 to 33, wherein the polyester backing layer has a weight of 50 to 200 gsm and a thickness of 0.5 mm to 10 mm.

Aspect 35. A cover for vehicle interior components, the cover comprising a fabric sheet comprising a yarn composed of polyester microfibers, the fabric sheet comprising a first face and a second face wherein the first face is an A-side surface with face yarns having separated and raised microfibers that provide a suede-like appearance and feel; and a polyester backing layer laminated to the second face of the fabric sheet via a polyester adhesive layer, the polyester backing layer having a weight of 50 to 300 gsm and a thickness of 0.5 mm to 10 mm, wherein 70 to 100 weight percent of the polyester comprising at least one of the fabric sheet, the polyester backing layer, and the polyester adhesive layer is recyclable.

Aspect 36. The cover of aspect 35, wherein the face yarn comprises a polyester yarn having a denier from 0.1 to 0.9 dpf.

Aspect 37. A cover for vehicle interior components, the cover comprising a fabric sheet comprising a yarn composed of polyester microfibers, the fabric sheet comprising a first face, a second face, and defining a first thickness, the first face corresponding to an A-side surface and defining a second thickness, the second thickness defining a portion of the first thickness, wherein the first face comprises a face yarn and a ground yarn, the face yarn extending through at least a first portion of the second thickness and comprising separated and raised microfibers that provide a suede-like appearance and feel; and a polyester backing layer laminated to the second face of the fabric sheet, wherein the ground yarn extends through at least a second portion of the second thickness.

Aspect 38. The cover of aspect 37, wherein the face yarn is composed of a polyester yarn having a denier from 0.1 to 0.9 dpf.

Aspect 39. The cover of aspects 37 or 38, wherein the ground yarn is composed of a polyester yarn having a denier from 0.1 to 3 dpf.

Any of the above devices or methods described in the aspects, and the features of each, may be combined with other devices or methods, or features of each, to integrate various aspects of the claims, aspects, and/or disclosures as described herein. Additionally, the device, construction, steps, features, or components describing the recyclable polyester mono-material cover may be incorporated in any order, combination, or arrangement.

While exemplary embodiments are described above, it is not intended that these embodiments describe all possible forms according to the disclosure. In that regard, the words used in the specification are words of description rather than limitation, and it is understood that various changes may be made without departing from the spirit and scope of the disclosure. As previously described, the features of various implementing embodiments may be combined to form further embodiments of the disclosure that may not be explicitly described or illustrated.

What is claimed is:

1. A cover comprising:
a fabric sheet comprising a yarn composed of polyester microfibers, the fabric sheet comprising a first face and a second face wherein the first face is an A-side surface with separated and raised microfibers that provide a suede-like appearance and feel; and
a polyester backing layer laminated to the second face of the fabric sheet.

2. The cover of claim 1, wherein the fabric sheet is a warp knitted fabric sheet or a weft-knitted fabric sheet.

3. The cover of claim 1, wherein the fabric sheet is a woven fabric sheet.

4. The cover of claim 1, wherein the polyester backing layer is laminated to the fabric sheet with a polyester adhesive layer.

5. The cover of claim 4, wherein the polyester adhesive layer comprises a polyester-based glue or a polyester film or a polyester web.

6. The cover of claim 1, wherein the polyester in at least one of the fabric sheet, the polyester backing layer, and the polyester adhesive layer comprises recycled polyester, ocean-waste recycled polyester, ocean-bound recycled polyester, or combinations thereof.

7. The cover of claim 1, wherein 70 to 100 weight percent of the polyester in at least one of the fabric sheet, the polyester backing layer, and the polyester adhesive layer is recyclable.

8. The cover of claim 1, wherein the fabric sheet further comprises a face yarn and a ground yarn, wherein the face yarn provides the separated and raised microfibers, and the ground yarn is interwoven with the face yarn and located away from the A-side surface when compared with the face yarn and provides support to the face yarn.

9. The cover of claim 8, wherein the face yarn is composed of a polyester yarn having a denier from 0.1 to 0.9 dpf.

10. The cover of claim 8, wherein the ground yarn is composed of a polyester yarn having a denier from 0.1 to 3 dpf.

11. The cover of claim 1, wherein the fabric sheet has a weight of 150 to 500 gsm.

12. The cover of claim 1, wherein the fabric sheet is formed by warp knitting, weft-knitting, weaving or other textile construction.

13. The cover of claim 1, wherein the polyester backing layer is nonwoven, knitted, woven, weft-knitted, a double-needle bar, or a back coating.

14. The cover of claim 1, wherein the polyester backing layer has a weight of 50 to 300 gsm and a thickness of 0.5 mm to 10 mm.

15. The cover of claim 14, wherein the polyester backing layer has a weight of 50 to 200 gsm and a thickness of 0.5 mm to 10 mm.

16. A cover comprising:
a fabric sheet comprising a yarn composed of polyester microfibers, the fabric sheet comprising a first face and a second face wherein the first face is an A-side surface with face yarns having separated and raised microfibers that provide a suede-like appearance and feel; and
a polyester backing layer laminated to the second face of the fabric sheet via a polyester adhesive layer, the polyester backing layer having a weight of 50 to 300 gsm and a thickness of 0.5 mm to 10 mm,
wherein 70 to 100 weight percent of the polyester comprising at least one of the fabric sheet, the polyester backing layer, and the polyester adhesive layer is recyclable.

17. The cover of claim 16, wherein the face yarn comprises a polyester yarn having a denier from 0.1 to 0.9 dpf.

18. A cover comprising:
a fabric sheet comprising a yarn composed of polyester microfibers, the fabric sheet comprising a first face, a second face, and defining a first thickness, the first face corresponding to an A-side surface and defining a second thickness, the second thickness defining a portion of the first thickness,
wherein the first face comprises a face yarn and a ground yarn, the face yarn extending through at least a first portion of the second thickness and comprising separated and raised microfibers that provide a suede-like appearance and feel; and
a polyester backing layer laminated to the second face of the fabric sheet,
wherein the ground yarn extends through at least a second portion of the second thickness.

19. The cover of claim 18, wherein the face yarn is composed of a polyester yarn having a denier from 0.1 to 0.9 dpf.

20. The cover of claim 18, wherein the ground yarn is composed of a polyester yarn having a denier from 0.1 to 3 dpf.
